(19) United States
(12) Patent Application Publication
(10) Pub. No.: US 2002/0171248 A1
(43) Pub. Date: Nov. 21, 2002

(54) Latching arrangement for a glove box

(76) Inventors: William F. Diss, Shelby Township, MI (US); Jack J. Serge, Novi, MI (US); Stephen R. Marriott, Rochester Hills, MI (US); Patrick H. Predd, Wixom, MI (US)

Correspondence Address: DAIMLERCHRYSLER INTELLECTUAL CAPITAL CORPORATION, CIMS 483-02-19, 800 CHRYSLER DR EAST, AUBURN HILLS, MI, 48326-2757, US

(21) Appl. No.: 09/862,662

(22) Filed: May 21, 2001

(51) Int. Cl. E05C 1/12

(52) U.S. Cl. 292/164

(57) ABSTRACT

A latch assembly includes a main body, a latch, a biasing spring and a handle. The latch is disposed within a cavity in the main body and is biased in an upward direction by the spring. The handle is hingedly attached to the main body and interfaces with the latch. The handle is also biased by the spring. The biasing force of the spring on the handle causes the handle to be flush with surrounding interior panels. The handle can be caused to pivot by an operator thus causing downward motion of the latch and enabling the door to be freely opened.

### FIELD OF THE INVENTION

The present invention relates generally to latching mechanisms for doors and more particularly to an improved latch assembly for a glove box.

### BACKGROUND OF THE INVENTION

Throughout the history of automobile development, automobile manufacturers have sought to improve customer safety and satisfaction while reducing costs and vehicle complexity. To achieve this, manufacturers look to all aspects of the vehicle for improvements in function, cost and reduction in the overall amount of parts. The quest for improvement encompasses components as complex as an engine to those as simple as a door latch.

Many latch mechanisms, such as those implemented in vehicle glove boxes, have been overly complex and as a result, expensive to produce. Additionally, traditional latch mechanisms often have not contoured to surrounding external surfaces. In other words, the latch handle did not maintain the same aesthetic qualities as the door panel or other surrounding panels. Advancements in door latch mechanisms have sought to reduce the complexity of the latching mechanism, and improve aesthetic qualities. However, room for improvements remains.

### SUMMARY OF THE INVENTION

It is a primary objective of the present invention to provide an improved latch assembly which is less complex and therefore less expensive to produce than conventional latch assemblies.

It is another object of the present invention to provide a latch assembly which enables the desired aesthetic characteristics of a vehicle interior to be maintained, specifically around the glove box area.

In achieving the above discussed and other objectives, the present invention provides an improved latch apparatus. The improved latching apparatus includes a main body having a cavity disposed therein. A plunger is disposed within, and is slidably interfaced with, the cavity to enable movement of the plunger between a latched position and an unlatched position. A spring mechanism is disposed between a bottom surface of the plunger and an internal surface of the cavity. The spring mechanism biases the plunger to the lock position. A handle is pivotally attached to the main body and is engaged with the plunger. As such, the handle enables an operator to move the plunger between the latch and unlatch positions and also holds the plunger within the cavity.

Being comprised as such, the implementation of a single spring achieves a biasing force on both the plunger and handle. This is advantageous over previous assemblies which require two or more springs to produce each required biasing force. Additionally, the biasing force of the spring on the handle causes the handle to remain flush against the surrounding interior vehicle panels thus maintaining the aesthetic qualities of the vehicle interior.

Further areas of applicability of the present invention will become apparent from the detailed description provided hereinafter. It should be understood that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a front view of a latch assembly constructed in accordance with the teachings of a preferred embodiment of the present invention and operatively associated with a glove box door of a motor vehicle.

FIG. 2 is a perspective view of the latch assembly removed from the exemplary environment of FIG. 1 for purposes of illustration.

FIG. 3 is a top view of the latch assembly of the present invention.

FIG. 4 is an exploded rear perspective view of the latch assembly of the present invention.

FIG. 5 is a front view of the main body of the latch assembly of the present invention.

FIG. 6 is a front view of a plunger of the latch assembly of the present invention.

### DETAILED DESCRIPTION OF THE PREFERRED EMBODIMENTS

At the outset, it is important to note that the herein described embodiment is a preferred embodiment and is merely exemplary in nature. Being exemplary, the preferred embodiment is in no way intended to limit the invention or its applications.

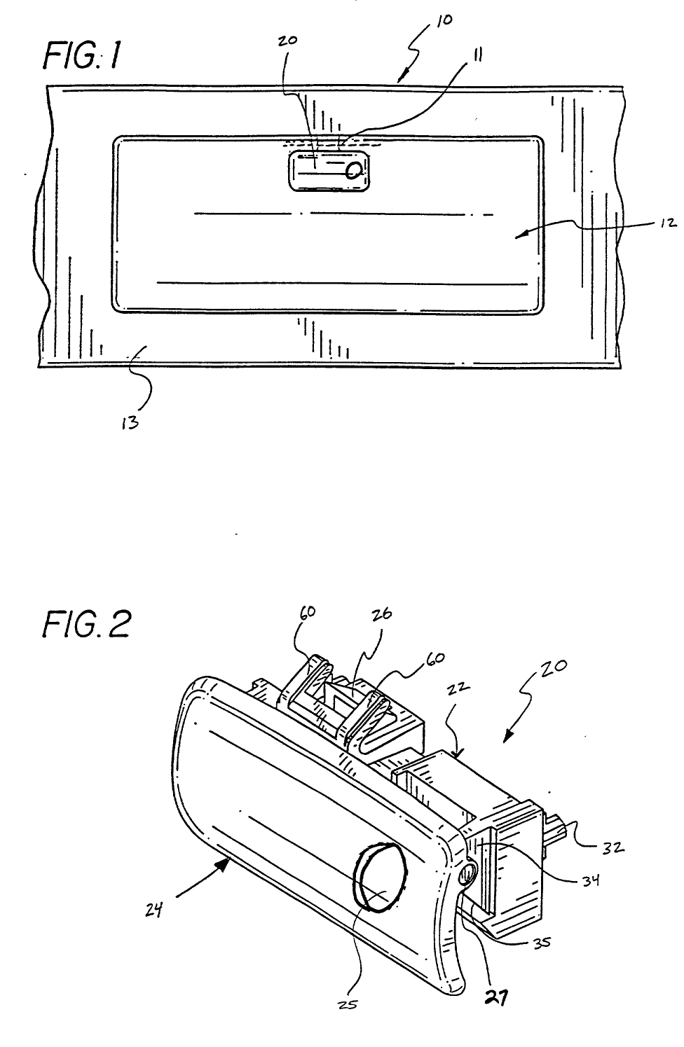

Referencing FIG. 1, a latch assembly 20 is shown operatively associated with a glove box 10 of a motor vehicle. Latch assembly 20 is mounted in a center upper portion of a door 12. Plunger assembly 26 interfaces with a striker 11, enabling an operator to selectively open door 12 or hold door 12 in a closed position.

FIG. 2 is a perspective view of latch assembly 20 removed from door 12. Latch assembly 20 is illustrated to generally include a main body 22, a handle 24 and a plunger 26. Latch assembly 20 is constructed such that plunger 26 is slidably mounted within main body 22 and is operable by handle 24. Handle 24 is hingedly attached to main body 22 for rotation about a pin 27. Handle 24 can optionally include an opening 25 (shown in phantom) for accessing a lock mechanism, described in further detail below.

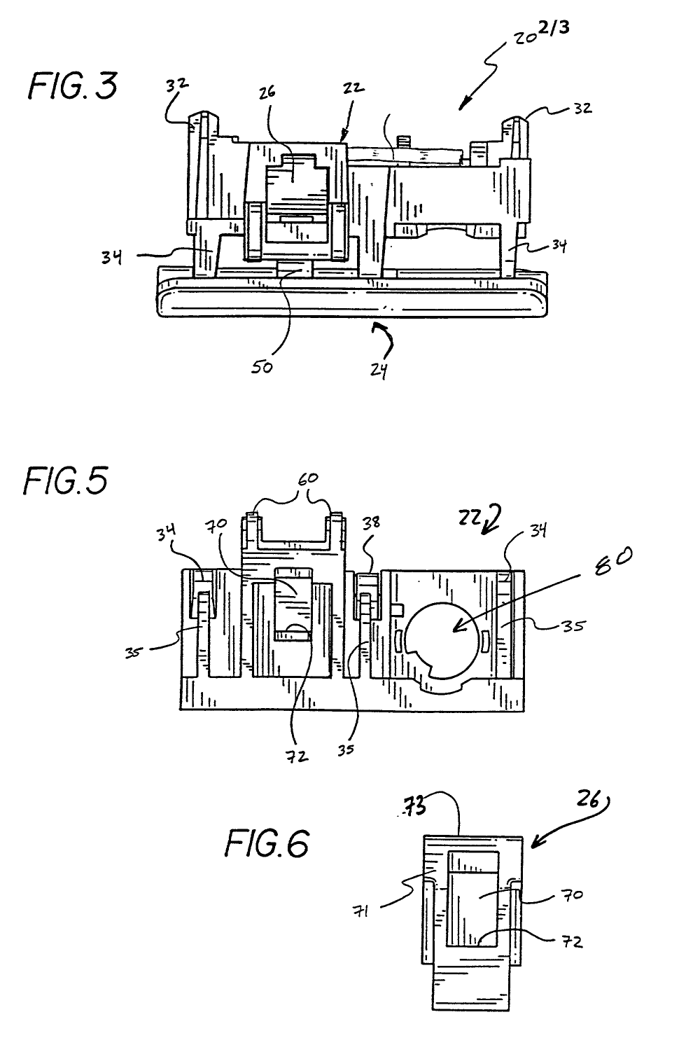

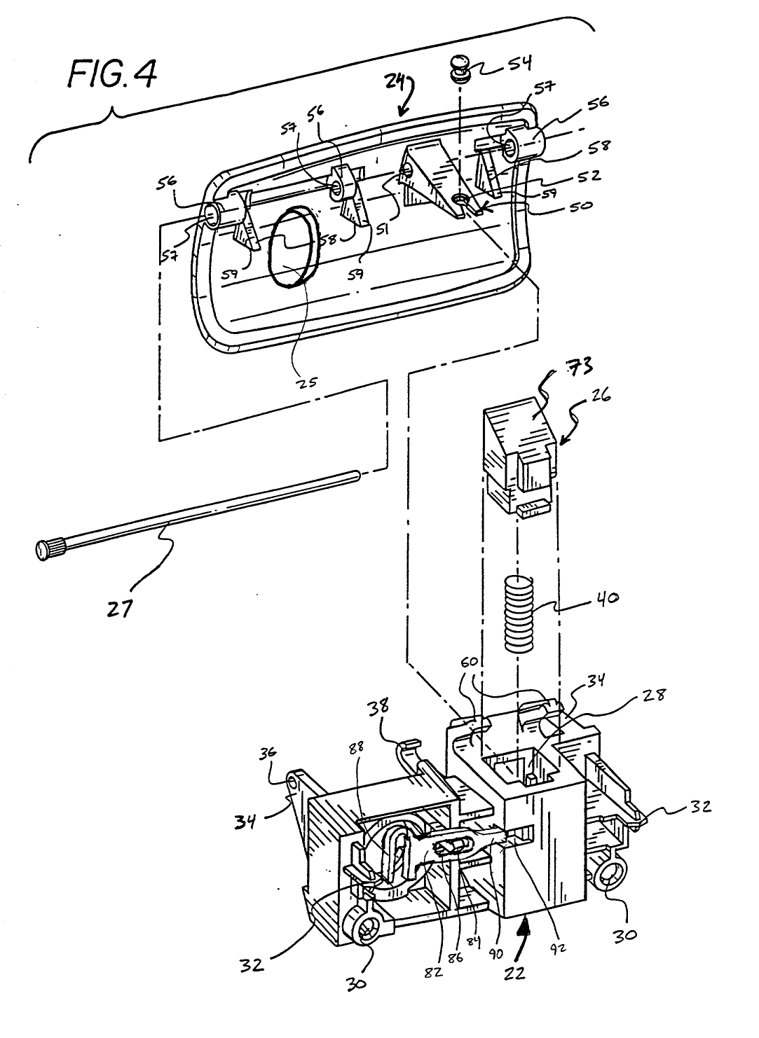

With reference to FIGS. 3, 4 and 5, the construction of latch assembly 20 will be described in greater detail. FIG. 4 is an exploded rear perspective view of latch assembly 20. Main body 22 has holes 30 for receiving fasteners (not shown) to fixedly attach latch mechanism 20 to the motor vehicle in a conventional manner. Main body 22 also has alignment pegs 32 for properly aligning latch assembly 20 during installation.

A cavity 28 is disposed within main body 22 which receives a biasing mechanism 40 and plunger 26. In the embodiment illustrated, biasing mechanism 40 is illustrated as a coil spring. As such, plunger 26 is slidable within cavity 28 and is biased in an upward direction by biasing mechanism 40.

Main body 22 also has arms 36 extending from the front for hingedly attaching handle 24. Arms 34 each have a hole 36 extending through, for receiving pin 27. The back face of handle 24 has a plurality of boss portions or brackets 56, each having a hole 57 therethrough. Additionally, an arm 50 extends from the back face of handle 24. Arm 50 has a first hole 51 extending horizontally through the base and a second hole 52 on the end. Second hole 52 receives and holds grommet 54. Arm 50 includes an end extending into cavity 28 and engaging plunger 26.

Brackets 56 align with arms 34 therefore, concentrically aligning holes 57 with holes 36. Once aligned, pin 27 runs through holes 36 of main body 22, holes 57 of brackets 56 and hole 51 of arm 50. As such, handle 24 is hingedly attached to main body 22 with pin 27 defining a hinge axis.

As best seen in FIG. 6, plunger 26 has an opening or cavity 70 cut through a rear face 71. Cavity 70 has a bottom surface 72. Additionally, an inclined surface 73 is disposed on top of plunger 26, which is best seen in FIG. 4. Upon assembly of handle 24 to main body 22, arm 50 is received into cavity 70 of plunger 26. Specifically, grommet 54 interfaces with bottom surface 72.

It is important to note that the interface between arm 50 and plunger 26 holds a significant mechanical advantage over prior latch assemblies. This interface enables biasing mechanism 40 to simultaneously perform two biasing functions at once. Initially, as previously described, biasing mechanism 40 biases plunger 26 in an upward direction to a lock position. This enables door 12 to be held closed continuously without further external influence. Secondly, the force of biasing mechanism 40 also biases arm 50 in an upward direction, thus biasing handle 24 downward as a result of a pivotal relationship between to a first position. Therefore, the force of biasing mechanism 40 enables handle 24 to remain in a closed position, flush with other body panels 13 (see e.g. FIG. 1) surrounding handle 24. To achieve the dual biasing action, latch assembly 20 of the present invention implements only biasing mechanism 40. This is advantageous over previous latch assemblies in that such previous latch assemblies typically require two or more springs to achieve the required biasing of plunger 26 or a rotating pawl in some designs, and handle 24.

In order to define a closed position, pivotal location for handle 24, supports 58 extend from the back surface of handle 24, as best seen in FIG. 4. Supports 58 include sloping surfaces 59. Additionally, as best seen in FIG. 5, arms 34 include sloping support surfaces 35. In a closed position, sloping surfaces 59 interface with sloping support surfaces 35 thus defining the pivotal location of handle 24 with respect to main body 22. For example, if the size of supports 58 gradually increased, handle 24 would be gradually forced to pivot upward, relative to main body 22, as a result of the interface with support surfaces 59. Alternatively, if the size of supports 58 gradually decreased, handle 24 would gradually pivot downward, biased by biasing mechanism 40, relative to main body 22.

With particular reference to FIGS. 4 and 5, a pair of curved receiving arms 60 extend from an upper surface of main body 22. Curved receiving arms 60 are disposed on either side of cavity 28 and plunger 26. Curved receiving arms 60, in conjunction with plunger 26, function to retain striker 11. Essentially, striker 11 is caught between curved receiving arms 60 and a back surface of plunger 26. This enables door 12 to remain in a closed position until an operator activates latch assembly 20 and releases striker 11 therefrom.

Upon closing door 12, inclined surface 73 interfaces with striker 11 such that plunger 26 is depressed into cavity 28. Once having cleared striker 11, biasing mechanism 40 biases plunger 26 back upward, thus securing door 12 in a closed position.

In operation, handle 24 can be manually caused to pivot upward about its hinged axis with main body 22 to a second position. Upward pivoting of handle 24 causes downward motion of arm 50. In turn, arm 50 acts on bottom surface 72 forcing downward motion of plunger 26 against the force of biasing mechanism 40. The downward motion causes plunger 26 to recede into cavity 28 to an unlock position. Once sufficiently within cavity 28, plunger 26 can no longer act on striker 11 thus allowing door 12 to freely open. During both opening and closing motions of handle 24, grommet 54 dampens any noise which would otherwise occur in the interface between arm 50 and bottom surface 72.

Main body 22 further includes an opening 80 for accessing a locking mechanism (not shown). The locking mechanism can be implemented to selectively lock latch assembly 20, thus prohibiting movement of handle 24. A portion of the locking mechanism, however, is shown as lock bar 82. Lock bar 82 is slidably supported on a post 84 extending from main body 22. Lock bar 82 includes an opening 86, for receiving post 84 and a U-shaped portion 88 for interfacing with the lock mechanism. A blocker 90 is also included which is slidable into an opening 92 of main body 22. Once slid into opening 92, blocker 90 prohibits downward motion of plunger 26, thus prohibiting pivot of handle 24.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the description of the appended claims.

What is claimed is:

1. A latching arrangement for a door, said latching arrangement comprising:
a main body defining a cavity;
a plunger disposed within said cavity, said plunger being movable between a lock position and an unlock position;
a handle pivotally attached to said main body and engaged with said plunger for movement of said plunger between said lock and unlock positions when said handle is caused to move from a first to a second position; and
a biasing mechanism disposed in said cavity and biasing said plunger to said lock position and biasing said handle to said first position.

2. The latching arrangement of claim 1, further comprising an arm radially extending from said handle, said arm including an end extending into said cavity and engaging said plunger for moving said plunger to said unlock position.

3. The latching arrangement of claim 1, wherein an upper surface of said plunger is sloped to cam said latch in a downward direction upon closing said door.

4. The latching arrangement of claim 1, wherein said main body further includes a plurality of arms for hingedly attaching said handle thereto.

5. The latching arrangement of claim 1, wherein said main body further includes at least one receiving arm for receiving a striker and subsequently functioning with said plunger for holding said striker thus holding said door in said closed position.

6. The latching arrangement of claim 1, wherein both said handle and said main body further include a plurality of supports for interfacing with one another thus pivotally locating said handle in said first position.

7. The latching arrangement of claim 1, wherein said main body further includes a plurality of holes for attaching said latching arrangement to a structure.

8. The latching arrangement of claim 1, wherein said main body further includes a plurality of alignment posts for aligning said latching arrangement during an assembly process.

9. The latching attachment of claim 1, wherein said biasing mechanism is a coil spring.

10. The latching arrangement of claim 2, wherein said plunger includes an opening, said arm received within said opening.

11. The latching arrangement of claim 1, further comprising a locking mechanism for prohibiting movement of said plunger to said unlock position.

12. A glove box for a vehicle, said glove box comprising:
an interior vehicle panel having a cavity disposed therein;
a door hingedly attached to said interior vehicle panel for selectively covering said cavity;
a striker provided on an inside edge of said cavity; and
a latching arrangement for selectively holding said door in a closed position, said latching arrangement including:
a main body having a cavity disposed therein;
a plunger disposed within said cavity, said plunger being movable between a lock position and an unlock position for selectively securing said door;
a handle pivotally attached to said main body and engaged with said plunger for movement of said plunger between said lock and unlock positions when said handle is caused to move from a first to a second position; and
a biasing mechanism disposed in said cavity and biasing said plunger to said lock position and biasing said handle to said first position.

13. The glove box of claim 12, further comprising an arm extending from said handle, said arm including an end extending into said cavity and engaging said plunger for moving said plunger to said unlock position.

14. The glove box of claim 12, wherein an upper surface of said plunger is sloped to cam said plunger in a downward direction upon closing said door.

15. The glove box arrangement of claim 12, wherein said main body further includes a plurality of arms for hingedly attaching said handle thereto.

16. The glove box of claim 12, wherein said main body further includes at least one receiving arm for receiving said door jam and subsequently functioning with said plunger for holding said door jam thus holding said door in said closed position.

17. The glove box of claim 12, wherein both said handle and said main body further include a plurality of supports for interfacing with one another thus pivotally locating said handle in said first position.

18. The glove box of claim 12, wherein said main body further includes a plurality of holes for attaching said latching arrangement to a structure.

19. The glove box of claim 12, wherein said main body further includes a plurality of alignment posts for aligning said latching arrangement during an assembly process.

20. The glove box of claim 12, wherein said biasing mechanism is a coil spring.

21. The glove box of claim 13, wherein said plunger includes an opening, said arm received with said opening.

22. The glove box of claim 12, further comprising a locking mechanism for prohibiting movement of said plunger to said unlock position.
